(19) United States
(12) Patent Application Publication
(10) Pub. No.: US 2007/0034319 A1
(43) Pub. Date: Feb. 15, 2007

(54) System and Process for Making and Applying a Flashing Seal

(75) Inventor: William Lanzetta, Center Moriches, NY (US)

Correspondence Address: WILLIAM COLLARD;COLLARD & ROE, P.C., 1077 NORTHERN BOULEVARD, ROSLYN, NY, 11576, US

(73) Assignee: ACE MANUFACTURING CORPORATION, Bohemia, NY (US)

(21) Appl. No.: 11/461,809

(22) Filed: Aug. 2, 2006

Related U.S. Application Data
(60) Provisional application No. 60/707,453, filed on Aug. 11, 2005.

(51) Int. Cl. B29C 65/00

(52) U.S. Cl. 156/192; 156/443; 428/457

(57) ABSTRACT

A process for manufacturing a dual layer building seal comprising a series of steps including providing a first roll of material, placing a second material in a region adjacent to the first material so that an open end of the first material matches with an open end of the second material. In addition this process can include coupling the first material to a spindle. There can be also a three ply sheet of copper, polyethylene and adhesive, and also a system for manufacturing the three ply layer. This system can include at least one spindle and also a compression mechanism wherein the spindle can be in the form of a mechanized spindle.

### CROSS REFERENCE TO RELATED APPLICATIONS

Applicant claims priority under 35 U.S.C. §119(e) from U.S. Provisional Application Ser. No. 60/707,453 filed on Aug. 11, 2005, the disclosure of which is hereby incorporated herein by reference.

### BACKGROUND OF THE INVENTION

The invention generally relates to a building seal or a flashingseal, and also a method for making a building seal or a flashingseal. In addition, the invention relates to a system for making a building seal or a flashingseal. A building seal or a flashingseal can be essentially a seal formed from a waterproof layer and a copper layer or a layer made substantially or at least partially from copper coupled together.

The following references generally relate to some form of a building seal: U.S. Pat. Nos. 5,979,123; 5,070,216; 3,852,931; 2,859,486; 2,235,758; and 2,165,500, wherein the disclosures of these patents are hereby incorporated herein by reference.

### SUMMARY OF THE INVENTION

The invention generally relates to a process for manufacturing a dual layer building seal comprises a series of steps including providing a first roll of material such as laying foam on a table, and placing a second material in a region adjacent to the first material so that an open end of the first material matches with an open end of the second material. In addition this process can include coupling the first material to a spindle.

Furthermore, this process can include coupling either the first material or a second material to a spindle which has a sprayed on glue and then starting and rotating the spindle to pull the first material. This process can also include continuously coupling the first material to the second material while the spindle is pulling both of the materials. Next, the process can include detaching a portion of the first material from the second material, and then coupling an inside region of the first material to a rolled up outside region of the first material on the spindle to form a closed roll.

In this case, the step of continuously coupling the first material to the second material occurs by using at least one adhesive.

This process can also include the step of continuously coupling the first material to the second material. This process can include spraying an adhesive onto either the first material or the second material.

This process can also include the step of continuously coupling the first material to the second material for a period of time and can further comprise compressing the first material and the second material together to form a joined material.

This process can further comprise the step of heating up the adhesive before using the adhesive for coupling the first material to the second material. In this case, this first material can be in the form of copper. This second material can be in the form of polyethylene.

As an option, the step of continuously compressing the first material together with the second material can comprise feeding the first material together with the second material through a compression block to press the first and the second material together.

This process can also include the step of cutting an uncoupled end of at least one of the first material or the second material together once either of the first material or the second material has run out.

In one embodiment, the adhesive is sprayed onto the second material.

The invention can also relate to a seal for a building comprising a first material made all, substantially all or at least partially from copper; a second material made all, substantially all or at least partially from polyethylene; and an adhesive for binding the copper sheet and the polyethylene sheet together.

As an option the second sheet or polyethylene sheet can be in the form of a ⅜″ thick sheet. In addition, this second sheet can be in the form of blown polyethylene.

The adhesive can be in the form of a thermal setting adhesive.

A system for manufacturing this product can include a spindle for winding material.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawings, wherein similar reference characters denote similar elements throughout the several views:

FIG. 1 shows a system for making the sealing barrier;

FIG. 2 shows a flow chart for a process for making a sealing barrier;

FIG. 3A shows a side view of the sealing barrier;

FIG. 3B shows a side view of the sealing barrier disposed between two building posts;

FIG. 3C shows a side view of a sealing barrier disposed between a foundation and a building post;

FIG. 4A shows a top view of a first stage of placing the sealing barrier on a foundation; and

FIG. 4B shows a cross sectional view of the sealing barrier on the foundation.

### DETAILED DESCRIPTION OF PREFERRED EMBODIMENTS

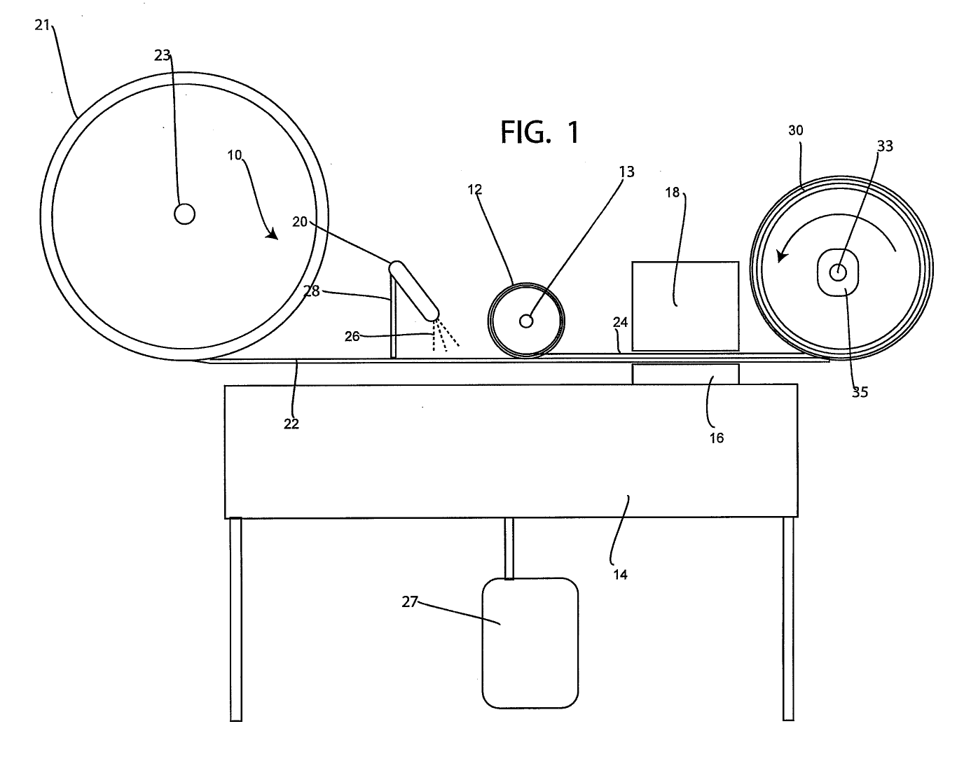

FIG. 1 shows a system for forming a building seal, or a flashing seal in an automated manner. In this case, the building or flashing seal can be in the form of first material which can be in the form of a strip comprising all, substantially all or at least partially copper. The first material can be formed in the form of a roll 12 which can be rolled out in a single thin strip 24. Roll 12 can be optionally placed on a spindle 13 for unraveling. In addition, a second material which can be in the form of an insulation material 22 can be formed as a polyurethane or polyethylene-type material or a material comprising at least some polyurethane or at least some polyethylene, that can be in the form of a foam type material. This second material can also be presented in the form of a roll 21 which is positioned around a spindle or axle 23. The flashing seal can be formed in the form of a final roll 30, which is formed as a combination of the copper sheet 24, and the insulation material 22. These rolls of material can be passed through a clamping mechanism in the form of a clamping station which can include clamping blocks 16 and 18 and then attached to an axle or spindle 33 which is driven by a motor 35.

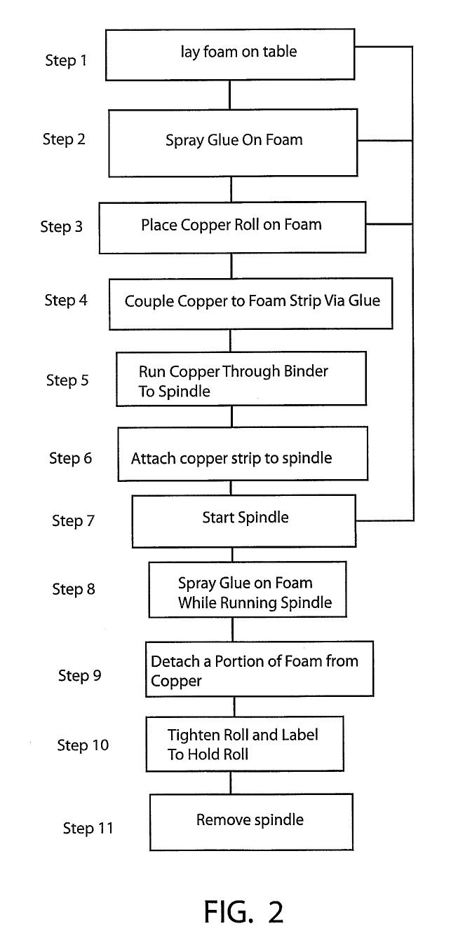

FIG. 2 shows a process for producing a building or flashing seal. The process occurs as follows: a user can lay foam on a table as shown in step 1 this foam can form the second sheet as disclosed above. For example, this foam may comprise ⅜″ inch thick polyethylene. Previously, the installation of a waterproofing shield between a house side and a foundation would include a waterproof barrier which can be in the form of a ¼″ barrier. With the present embodiment, this foam or second sheet can be passed through a pressing or binding station which can be used to press the copper strip onto the foam.

Next in step 2, a user can spray a glue on the foam. This glue can be in the form of a hot melt glue wherein the glue is heated up in a hot melt chamber 27 as shown in FIG. 1.

Next, as shown in step 3, a user can place a copper roll or first material as disclosed above on the foam. Next, as shown in step 4, the copper strip can be coupled to the second material or foam. This can be achieved by spraying on or otherwise applying a thermal adhesive or glue to either the inside surface of the copper strip or the foam strip or both.

Next, as shown in step 5 the first material or copper can be run through the binding station past binding blocks 16 and 18 to the spindle. Next, as shown in step 6, the first material or copper strip can be attached to spindle 33. This can occur via a thermal adhesive that can be sprayed onto the spindle. At this point, a free end of the first material or copper strip can be wrapped around the spindle which retains a thermal adhesive or glue. In step 7, the user can start the spindle thus causing the copper strip to wrap around the spindle and also pull the remaining portion of copper strip which is coupled to the foam. During step 8, the spindle keeps running, such that the first material or copper roll which is sitting on top of the second material foam unravels or unrolls. At this point, at a point just before this copper strip unrolls, a user can continuously apply the thermal adhesive or glue to the second material or foam or first material or copper such that as the first material or copper roll unravels, it is pressed or is applied to the second material or foam when it passes through the pressing or binding mechanism or station.

As stated above, the pressing or binding mechanism or station can be in the form of blocks 16 and 18 which create a gap or opening which may be a thinner opening than the uncompressed three layers of the second sheet or material or foam, adhesive and first sheet or material or copper strip. When this three-ply strip passes this station, it presses this copper strip down onto the foam layer, compressing the foam layer and thereby applying pressure to this foam layer.

This pressing of the first material or copper strip into the second material or foam while the adhesive, or glue is cooling, drying, or fixing creates a uniform adhesion of the second material or foam into the first material or copper for a layered product.

In step 9, as most of the roll becomes unraveled, a user can detach a portion of either the first material or copper or the second material or foam from each other such that there is a strip of exposed copper strip. The user can then spray or otherwise apply the adhesive to the first material or copper strip and in step 10, tighten the roll and place the label on the roll to allow the first material or copper strip to wrap around the roll and form a closed end roll.

Next, in step 11, the user can cut the free end of the foam and/or the copper and then wrap the exposed end of copper having the adhesive on it around the remaining portion of the rod.

In step 11, the user can remove the spindle from the roll, apply a label and wrap this label around a roll for safe storage before shipment.

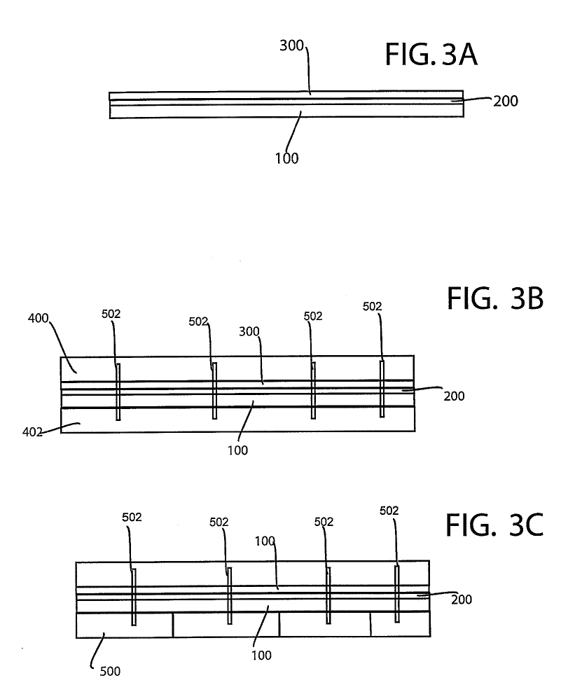

A cross-section of this final end product is shown in FIG. 3A which shows a three-layer system including a metallic termite barrier 100 which can be in the form of a first material or copper sheet, an adhesive layer 200 which as described above, can be for example in the form of a thermal adhesive known as a spray adhesive hot melt glue 702. This third layer 300 or second sheet can be in the form of a polyethylene foam which can be ⅜″ thick. FIG. 3B shows a cross-sectional view of this three layer system which can be used such that it is placed in between two components such as a foundation 500 and a beam 402 (see FIG. 3C).

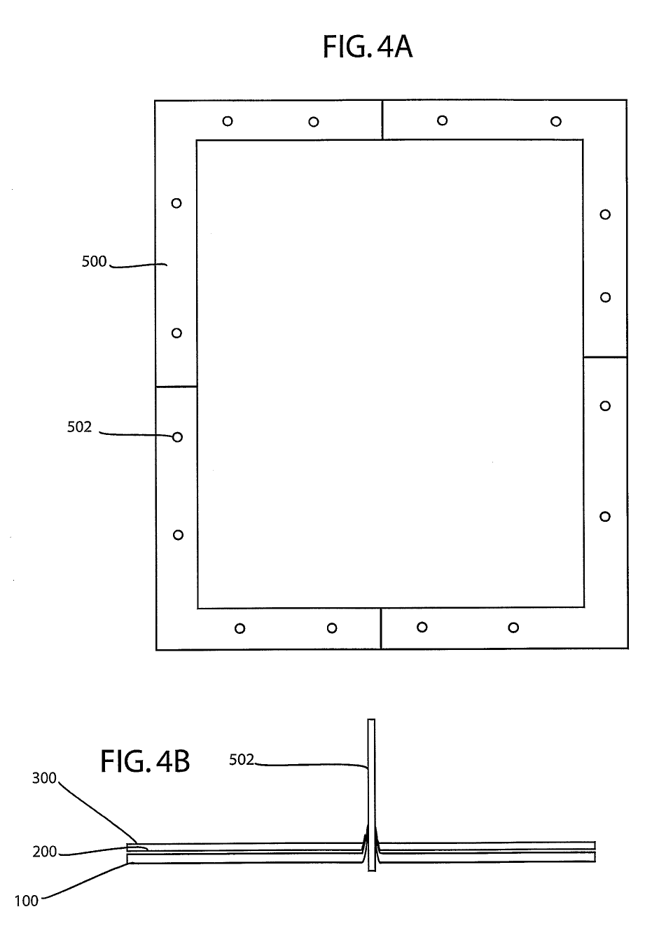

FIG. 4A shows this three layer system which is placed on top of a foundation 500. Foundation 500 can have a plurality of metal rods 502 which extend up out from this foundation. These metal rods 502 can be in the form of iron or steel bars that can be cemented into foundation 500. Under previous circumstances, prior to the present invention, a user would have to first place down a water proofing barrier which could be in the form of a polyethylene sheet such as a ¼″ polyethylene sheet. This polyethylene sheet could be relatively low in density and thus light for its size, and as such, be susceptible to blowing away. Thus, under these normal circumstances, a user may have a hard time inserting or applying just this polyethylene layer.

Instead, the user can apply the three-part product all at once so that the first material or copper layer 300 on top of the second material or polyethylene layer 100 keeps the second material or polyethylene layer from blowing away.

When a user is actually applying the three layer product, he or she can press this product down over rods 502. The act of pressing this three-layer sheet over rods 502 causes a break or hole in the sheet, wherein these rods punch through a relatively central region of this sheet to secure it against any lateral motion. The punching action, in most, if not all cases forces the second material or polyethylene layer up and against the copper layer to keep the first material or copper layer away from metal rods 502. This break in the three layer system keeps the copper layer from forming any kind of reaction with the metal foundation rods 502 as shown in FIG. 4B.

Accordingly, while a few embodiments of the present invention have been shown and described, it is to be understood that many changes and modifications may be made thereunto without departing from the spirit and scope of the invention as defined in the appended claims.

What is claimed is:

1. A process for manufacturing a dual layer building seal comprising the following steps:
a) providing a first material;
b) placing a second material in a region adjacent to said first material so that an open end of said first material matches with an open end of said second material;
c) coupling said first material to a spindle;
d) coupling a first section of said first material to a section of said second material;
e) rotating said spindle to pull said first material;
e) continuously coupling said first material to said second material;
f) detaching a portion of said first material from said second material; and
g) coupling an inside region of said first material to an outside region of said first material on said spindle to form a closed roll.

2. The process as in claim 1, wherein said step of continuously coupling said first material to said second material occurs by using at least one adhesive.

3. The process as in claim 2, wherein said step of continuously coupling said first material to said second material includes spraying an adhesive onto said second material.

4. The process as in claim 3, wherein said step of continuously coupling said first material to said second material further comprises compressing said first material and said second material together to form a joined material.

5. The process as in claim 2, further comprising the step of heating said adhesive before using said adhesive for coupling said first material to said second material.

6. The process as in claim 1, wherein said first material comprises copper.

7. The process as in claim 1, wherein said second material comprises polyethylene.

8. The process as in claim 4, wherein said step of continuously compressing said first material together with said second material comprises feeding said first material together with said second material through a compression block to press said first and said second material together.

9. The process as in claim 1, further comprising cutting an uncoupled end of at least one of said first material or said second material together once either of said first material or said second material has run out.

10. The process as in claim 2, wherein said adhesive is sprayed onto said second material.

11. A seal for a building comprising:
a) a first sheet of material made substantially from copper;
b) a second sheet of material made substantially from polyethylene; and
c) an adhesive for binding said first sheet and said second sheet together.

12. The seal as in claim 11, wherein said second sheet is in the form of a ⅜″ sheet.

13. The seal as in claim 11, wherein said second sheet is in the form of blown polyethylene.

14. The seal as in claim 11, wherein said adhesive comprises a thermal setting adhesive.

15. A system for manufacturing a multi-ply product comprising:
a) a spindle for winding a product up;
b) an adhesive applier;
c) a feed for a waterproof sheet;
d) a feed for a termite control sheet; and
e) a compression mechanism for compressing said waterproof sheet said termite control sheet and said adhesive together, wherein said termite control sheet and said waterproof sheet are wound around each other.
